(19) United States
(12) Patent Application Publication
(10) Pub. No.: US 2024/0339852 A1
(43) Pub. Date: Oct. 10, 2024

(54) POWER CONTROL METHOD AND POWER CONTROL SYSTEM

(71) Applicant: ASUSTEK COMPUTER INC., TAIPEI (TW)

(72) Inventor: Tzu-Nan CHENG, TAIPEI (TW)

(21) Appl. No.: 18/359,622

(22) Filed: Jul. 26, 2023

(30) Foreign Application Priority Data
Apr. 10, 2023 (CN) 202310372508.3

(51) Int. Cl. H02J 7/00

(52) U.S. Cl. CPC H02J 7/007182

(57) ABSTRACT

A power control method, applied to an electronic device. The electronic device may enter a non-running state and includes a connector and a battery module. The connector is suitable for connecting a charger. The power control method includes: obtaining, after confirming that the charger is connected to the connector, charging information of the charger; reading a battery voltage of the battery module; generating, after confirming that the electronic device enters the non-running state, an energy saving voltage according to the charging information and the battery voltage; and adjusting an output setting of the charger according to the energy saving voltage. A power control system is also provided.

### CROSS-REFERENCE TO RELATED APPLICATION

This application claims the priority benefit of China application serial no. 202310372508.3, filed on Apr. 10, 2023. The entirety of the above-mentioned patent application is hereby incorporated by reference herein and made a part of this specification.

### BACKGROUND OF THE DISCLOSURE

### Field of the Invention

The disclosure relates to the technical field of power control, and in particular, to a power control method and a power control system which are applicable to an electronic device.

### Description of the Related Art

In a traditional electronic device, such as a notebook computer, a charger supplies power to an electronic device at a rated voltage in a standby mode. However, because the rated voltage is a fixed value, when the rated voltage is lower than a battery voltage, a problem of battery discharge is easily generated. In addition, when a voltage difference between the rated voltage and the battery voltage is too large, a problem of large energy consumption in the standby mode is also easily generated. With an increase of output power of the charger, the problems are more obvious.

### BRIEF SUMMARY OF THE INVENTION

The disclosure provides a power control method, applied to an electronic device. The electronic device has a non-running state and includes a connector and a battery module. The connector is suitable for connecting a charger. The power control method includes: obtaining, after confirming that the charger is connected to the connector, charging information of the charger; reading a battery voltage of the battery module; generating, after confirming that the electronic device enters the non-running state, an energy saving voltage according to the charging information and the battery voltage; and adjusting an output setting of the charger according to the energy saving voltage.

The disclosure also provides a power control system. The power control system is arranged in an electronic device. The electronic device has a non-running state and includes a connector and a battery module. The connector is suitable for connecting a charger. The power control system includes a charging control unit and a control unit. The charging control unit is electrically coupled to the connector, and is configured to communicate with the charger. The control unit is electrically coupled to the charging control unit and the battery module and is configured to: obtain, after confirming that the charger is connected to the connector, charging information of the charger through the charging control unit; read a battery voltage of the battery module; generate, after confirming that the electronic device enters the non-running state, an energy saving voltage according to the charging information and the battery voltage; and adjust an output setting of the charger through the charging control unit according to the energy saving voltage.

According to the power control method and the power control system of the disclosure, a better energy saving voltage may be generated according to the battery voltage and the charging information of the charger, to replace a rated voltage used in the conventional technology. In this way, battery discharge caused by the battery voltage being higher than the rated voltage may be avoided, and a problem of excessive power consumption caused by a large pressure difference between the battery voltage and the rated voltage may also be avoided.

### BRIEF DESCRIPTION OF THE DRAWINGS

FIG. 1 is a schematic block diagram of a power control system according to an embodiment of the disclosure;

FIG. 2 is a flowchart of a power control method according to an embodiment of the disclosure;

FIG. 3 shows an embodiment of step S250 in FIG. 2;

FIG. 4 shows another embodiment of step S250 in FIG. 2; and

FIG. 5 and FIG. 6 are flowcharts of a power control method according to another embodiment of the disclosure.

List of reference numerals is as follows:

### DETAILED DESCRIPTION OF THE EMBODIMENTS

More detailed descriptions of specific embodiments of the disclosure are provided below with reference to the schematic diagrams. The features and advantages of the disclosure are described more clearly according to the following description and claims. It should be noted that all of the drawings use very simplified forms and imprecise proportions, only being used for assisting in conveniently and clearly explaining the objective of the embodiments of the disclosure.

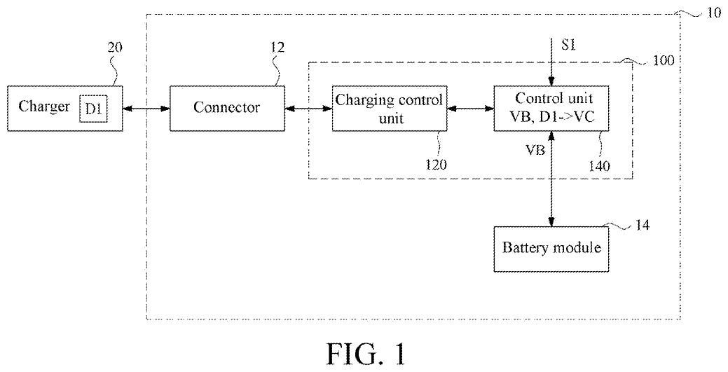

FIG. 1 is a schematic block diagram of a power control system according to an embodiment of the disclosure.

The power control system 100 is arranged in an electronic device 10. The electronic device 10 provides a plurality of different states, such as a running state, or a non-running state. The non-running state is a sleep state or a soft off state. According to a definition of advanced configuration and power interface (Advanced Configuration and Power Interface, ACPI). The sleep state corresponds to G1 state in the ACPI, which includes a so-called sleep mode and hibernate mode, and the soft off state corresponds to G2 state in the ACPI.

The electronic device 10 also includes a connector 12 and a battery module 14. The connector 12 is suitable for connecting a charger 20 and is electrically coupled to the battery module 14. In an embodiment, the connector 12 is a USB type-C connector.

The power control system 100 includes a charging control unit 120 and a control unit 140. The charging control unit 120 is electrically coupled to the connector 12, and is configured to communicate with the charger 20, for example, obtaining charging information D1 of the charger 20. The charging information D1 may include code of the charger 20 and the charging capacity.

The control unit 140 is electrically coupled to the charging control unit 120 and the battery module 14, and is configured to read battery voltage VB of the battery module 14 and control the operation of the charging control unit 120. There are more detailed descriptions in subsequent paragraphs for details of the operation of the control unit 140.

In an embodiment, the charging control unit 120 may be a USB PD (USB PD) chip in cooperation with the used connector 12. In an embodiment, the control unit 140 may be an embedded controller (EC).

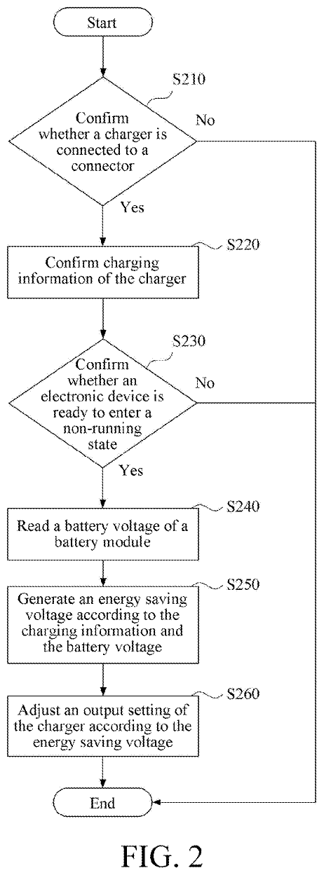

FIG. 2 is a flowchart of a power control method according to an embodiment of the disclosure. The power control method is applied to the power control system 100 shown in FIG. 1. The power control method includes the following steps.

Firstly, as described in step S210, it is confirmed whether the charger 20 is connected to the connector 12. This step may be performed by the control unit 140 in cooperation with the charging control unit 120 in FIG. 1. If the charger 20 is not connected to the connector 12, the process ends.

After confirming that the charger 20 is connected to the connector 12, as described in Step S220, the charging information D1 of the charger 20 is obtained. This step may be performed by the control unit 140 in cooperation with the charging control unit 120 in FIG. 1.

Next, as described in step S230, it is confirmed whether the electronic device 10 is ready to enter the non-running state. This step may be performed by the control unit 140 in FIG. 1. If the electronic device 10 is not ready to enter the non-running state, the process ends.

After confirming that the electronic device 10 is ready to enter the non-running state, as described in step S240, the battery voltage VB of the battery module 14 is read. This step may be performed by the control unit 140 in FIG. 1.

Then, as described in step S250, an energy saving voltage VC is generated according to the charging information D1 and the battery voltage VB. This step may be performed by the control unit 140 in FIG. 1.

Then, as described in step S260, an output setting of the charger 20 is adjusted according to the energy saving voltage VC. Specifically, a voltage level outputted by the charger 20 is adjusted to the energy saving voltage VC. This step may be performed by the control unit 140 in cooperation with the charging control unit 120 in FIG. 1.

In an embodiment, the control unit 140 may determine whether it is ready to enter the non-running state according to whether a trigger signal S1 is received. The trigger signal S1 may be an action corresponding to a screen of a notebook computer, an action corresponding to the pressing of a power button, or a specific instruction corresponding to a computer operating system. In an embodiment, the control unit 140 may determine whether the electronic device 10 is ready to enter the non-running state according to whether the electronic device 10 is idle for more than a preset time.

According to the charging control method of the disclosure, a better energy saving voltage VC may be generated according to the battery voltage VB and the charging information D1 of the charger 20, to replace a rated voltage used in the conventional technology. In this way, battery discharge caused by the battery voltage VB being higher than the rated voltage may be avoided, and a problem of excessive power consumption caused by a large pressure difference between the battery voltage VB and the rated voltage may also be avoided.

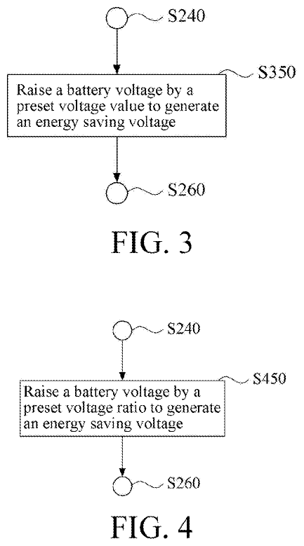

FIG. 3 shows an embodiment of step S250 in FIG. 2.

As shown in the figure, following step S240, after reading the battery voltage VB of the battery module 14, as described in step S350, the battery voltage VB is raised by a preset voltage value to generate an energy saving voltage VC.

In an embodiment, the preset voltage value ranges from 0.2 V and 0.5 V. For example, assuming that the preset voltage value is 0.3 V, if the battery voltage VB is 18 V, the generated energy saving voltage VC is 18.3 V.

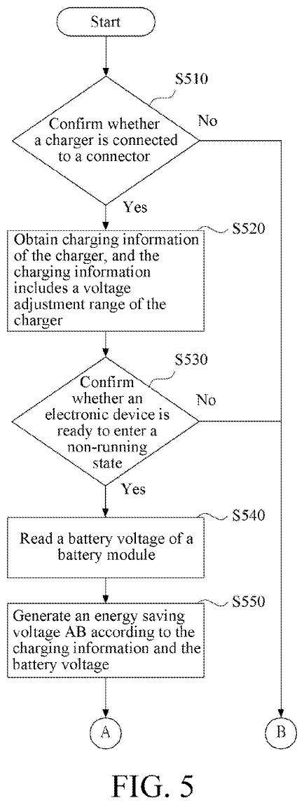

FIG. 4 shows another embodiment of step S250 in FIG. 2.

As shown in the figure, following step S240, after reading the battery voltage VB of the battery module 14, as described in step S450, the battery voltage VB is raised by a preset voltage ratio to generate an energy saving voltage VC.

In an embodiment, the preset voltage ratio ranges from 1% to 3%. For example, assuming that the preset voltage ratio is 2%, if the battery voltage VB is 18 V, the generated energy saving voltage VC is 18.36 V.

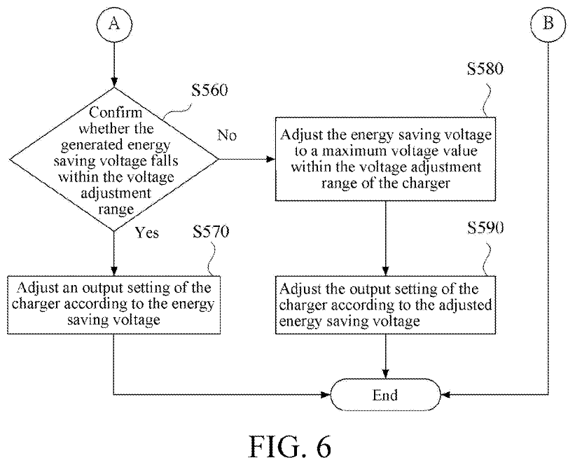

FIG. 5 and FIG. 6 are flowcharts of a power control method according to another embodiment of the disclosure. The power control method is applied to the power control system 100 shown in FIG. 1. The power control method includes the following steps.

Firstly, as described in step S510, it is confirmed whether the charger 20 is connected to the connector 12. This step may be performed by the control unit 140 in cooperation with the charging control unit 120 in FIG. 1. If the charger 20 is not connected to the connector 12, the process ends.

After confirming that the charger 20 is connected to the connector 12, as described in Step S520, charging information D1 of the charger 20 is obtained. The charging information D1 includes a voltage adjustment range of the charger 20. This step may be performed by the control unit 140 in cooperation with the charging control unit 120 in FIG. 1.

Next, as described in step S530, it is confirmed whether the electronic device 10 is ready to enter the non-running state. This step may be performed by the control unit 140 in FIG. 1. If the electronic device 10 is not ready to enter the non-running state, the process ends.

After confirming that the electronic device 10 is ready to enter the non-running state, as described in step S540, the battery voltage VB of the battery module 14 is read. This step may be performed by the control unit 140 in FIG. 1.

Then, as described in step S550, an energy saving voltage VC is generated according to the charging information D1 and the battery voltage VB. This step may be performed by the control unit 140 in FIG. 1.

Then, as described in step S560, it is confirmed whether the generated energy saving voltage VC falls within the voltage adjustment range. This step may be performed by the control unit 140 in FIG. 1.

If the energy saving voltage VC falls within the voltage adjustment range, as described in Step S570, an output setting of the charger 20 is adjusted according to the energy saving voltage VC. This step may be performed by the control unit 140 in cooperation with the charging control unit 120 in FIG. 1.

If the energy saving voltage VC exceeds the voltage adjustment range, as described in Step S580, the energy saving voltage VC is adjusted to a maximum voltage value within the voltage adjustment range of the charger 20. For example, assuming that the generated energy saving voltage VC in step S550 is 34.3 V, and the voltage adjustment range of the charger 20 ranges from 20 V to 34.2 V, the energy saving voltage VC is adjusted to 34.2 V. Then, as described in step S590, an output setting of the charger 20 is adjusted according to the adjusted energy saving voltage VC. This step may be performed by the control unit 140 in cooperation with the charging control unit 120 in FIG. 1.

According to the power control method and the power control system of the disclosure, a better energy saving voltage may be generated according to the battery voltage and the charging information of the charger, to replace a rated voltage used in the conventional technology. In this way, battery discharge caused by the battery voltage being higher than the rated voltage may be avoided, and a problem of excessive power consumption caused by a large pressure difference between the battery voltage and the rated voltage may also be avoided.

Although the disclosure is described with reference to the above embodiments, the embodiments are not intended to limit the disclosure. A person skilled in the art may make variations and modifications without departing from the spirit and scope of the disclosure. Therefore, the protection scope of the disclosure is subject to the claims.

What is claimed is:

1. A power control method, applied to an electronic device, wherein the electronic device has a non-running state and comprises a connector and a battery module, the connector is suitable for connecting a charger, and the power control method comprises:
obtaining, after confirming that the charger is connected to the connector, charging information of the charger;
reading a battery voltage of the battery module;
generating, after confirming that the electronic device enters the non-running state, an energy saving voltage according to the charging information and the battery voltage; and
adjusting an output setting of the charger according to the energy saving voltage.

2. The power control method according to claim 1, wherein the step of generating the energy saving voltage according to the charging information and the battery voltage comprises:
raising the battery voltage by a preset voltage value to generate the energy saving voltage.

3. The power control method according to claim 2, wherein the preset voltage value ranges from 0.2 V to 0.5 V.

4. The power control method according to claim 1, wherein the charging information comprises a voltage adjustment range of the charger, and after the step of generating the energy saving voltage according to the charging information and the battery voltage, the power control method further comprises:
confirming whether the generated energy saving voltage falls within the voltage adjustment range; and
adjusting, if the energy saving voltage exceeds the voltage adjustment range, the energy saving voltage to a maximum voltage value within the voltage adjustment range.

5. The power control method according to claim 1, wherein the step of generating the energy saving voltage according to the charging information and the battery voltage comprises:
raising the battery voltage by a preset voltage ratio to generate the energy saving voltage.

6. The power control method according to claim 5, wherein the preset voltage ratio ranges from 1% to 3%.

7. The power control method according to claim 1, wherein the non-running state is a sleep state or a soft off state.

8. A power control system, applied to an electronic device, wherein the electronic device has a non-running state and comprises a connector and a battery module, the connector is suitable for connecting a charger, and the power control system comprises:
a charging control unit, electrically coupled to the connector, and configured to communicate with the charger; and
a control unit, electrically coupled to the charging control unit and the battery module, and configured to:
obtain, after confirming that the charger is connected to the connector, the charging information of the charger through the charging control unit;
read a battery voltage of the battery module;
generate, after confirming that the electronic device enters the non-running state, an energy saving voltage according to the charging information and the battery voltage; and
adjust an output setting of the charger through the charging control unit according to the energy saving voltage.

9. The power control system according to claim 8, wherein the connector is a universal serial bus type-C connector.

10. The power control system according to claim 8, wherein the charging control unit is a universal serial bus power delivery chip.
